(19) United States
(12) Patent Application Publication
(10) Pub. No.: US 2017/0357452 A1
(43) Pub. Date: Dec. 14, 2017

(54) HARDWARE ACCELERATED SYSTEM AND METHOD FOR COMPUTING HISTOGRAMS

(71) Applicant: U.S.A. as represented by the Administrator of the National Aeronautics and Space Administration, Washington, DC (US)

(72) Inventor: KYLE J. GREGORY, ADELPHI, MD (US)

(21) Appl. No.: 15/179,651

(22) Filed: Jun. 10, 2016

(51) Int. Cl. G06F 3/06

(52) U.S. Cl. CPC G06F 3/0608; G06F 3/061; G06F 3/0631; G06F 3/0673; G06F 3/0659

(57) ABSTRACT

A system and method for computing a histogram using a field programmable gate array (FPGA) device. A processor of the FPGA writes measurement data including values into a histogram computing module, the values includes histogram bins defining an interval including a minimum value, a maximum value, and one or more values lying between the minimum and maximum values. The histogram computing module is configured to compute the histogram based on the measurement data, and includes a dual port block random access memory for storing the measurement data, and an increment logic module for computing the histogram. For each of the bins stored in a memory, the increment logic module is configured to read a value from a bin; increment the value by one when the value is less than a pre-defined histogram bin threshold; and write the incremented value back to the memory to compute the histogram.

### INVENTION BY GOVERNMENT EMPLOYEE(S) ONLY

The invention described herein was made by an employee of the United States Government, and may be manufactured and used by or for the Government for governmental purposes without the payment of any royalties thereon or therefor.

### ORIGIN OF INVENTION

### Field

The aspects of the present disclosure relate generally to logic hardware configurations, and in particular to a hardware accelerated system and method for computing histograms.

### BACKGROUND

In recent years, there had been rapid increase in use of digital computing devices, which in turn have resulted into generation of large volume of digital data. In this digital world, data computation has been a challenge as huge amount of data can be generated through many sources. Data computation is an interdisciplinary field about processes and systems to extract knowledge or insights from data in various forms; either structured or unstructured that is a continuation of some of the data analysis fields such as histogram, statistics, data mining etc. This data can be in any form such as image, video, file, document or audio. Further, the data may include measurement data in the form of numerals, images, and quantitative variables. Examples of the measurement data may include, but are not limited to, time related data, temperature data, voltage data, and so forth. The critical element for efficiently managing and analyzing large volumes of such data is representing this data in the form of graphs.

Presently, there exist many techniques for managing data including storing data in form of histograms computed based on the data from a high precision rasterization data pipeline. A histogram is a graphical representation, such as a bar graph, showing a frequency distribution, or some function of numerical data. In the histogram, height of vertical rectangles is proportionate to corresponding frequencies of data. Further, it is an estimate of the probability distribution of a continuous variable (such as, quantitative variable).

An existing data managing technique uses an embedded processor for computing histograms based on the data as discussed herewith. For computing a histogram, the embedded processor may clear a space in memory by writing zero to all the locations in the memory. Then for each histogram count, the embedded processor may read a value from a memory location and increment the value by one, and thereafter write the new incremented value back into a memory location. Thus, there is huge computation load on the processor and due to this the problem of time complexity may arise in processing. In addition, the processor may get burdened as a number of transactions are performed. Further, computation time for computing the histogram may increase as the processor may also be performing other instructions while computing the histogram.

Accordingly, it would be desirable to provide a logic hardware configuration that addresses at least some of the problems identified above.

### SUMMARY

The aspects of the disclosed embodiments are directed to a logic design for computing a histogram based on individual measurements taken serially. The aspects of the disclosed embodiments provide advantages in memory savings and speed of computing a histogram. Advantageously, the aspects of the disclosed embodiments can eliminate the need for a general purpose process to perform the histogram computation.

According to a first aspect, the disclosed embodiments are directed to a system for computing a histogram. In one embodiment, the system includes a processor and a histogram computing module. The processor and histogram computing module are part of a Field Programmable Gate Array (FPGA) device. The processor is configured to write measurement data comprising a plurality of values into the histogram computing module, the plurality of values of the measurement data comprising a plurality of histogram bins, wherein each of the plurality of histogram bins defines an interval including a minimum value, a maximum value, and one or more values of the plurality of values lying between the minimum value and the maximum value. The histogram computing module is configured to compute the histogram based on the measurement data. The histogram computing module includes a dual port block random access memory configured to store the measurement data, and an increment logic module configured read a value of the one or more values from a histogram bin from at least one of the plurality of histogram bins; increment the read value by one when the read value is less than a pre-defined histogram bin threshold; and write the incremented value back to the dual port block random access memory.

In another aspect, the disclosed embodiments are directed to computing a histogram using a Field Programmable Gate Array (FPGA) device that includes at least a processor and a histogram computing module. In one embodiment, the method includes writing measurement data comprising a plurality of values into a dual port block random access memory of the histogram computing module, wherein the plurality of values of the measurement data comprise a plurality of histogram bins, and each of the plurality of histogram bins defines an interval including a minimum value, a maximum value, and one or more values of the plurality of values lying between the minimum value and the maximum value; and computing the histogram corresponding to the written measurement data by: reading a value from a histogram bin for each of the plurality of histogram bins stored in the dual port block random access memory; incrementing the read value by one when the read value is less than a pre-defined histogram bin threshold; and writing the incremented value back to the dual port block random access memory.

The disclosed embodiments substantially eliminate or at least partially address the aforementioned problems in the prior art, and enable management of large volume of data by computing a histogram without overloading a processor. The aspects of the disclosed embodiments also eliminate the need for a general purpose processor or other software to be involved in the generation of the histogram.

These and other aspects, implementation forms, and advantages of the exemplary embodiments will become apparent from the embodiments described herein considered in conjunction with the accompanying drawings. It is to be understood, however, that the description and drawings are designed solely for purposes of illustration and not as a definition of the limits of the disclosed invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the following, the invention will be explained in more detail with reference to the example embodiments shown in the drawings, in which:

FIG. 1 is an illustration of an exemplary system or device for computing a histogram, incorporating an aspect of the disclosed embodiments;

FIG. 2 is a block diagram illustrating various system elements or devices of an exemplary histogram computing module incorporating aspects of the disclosed embodiments;

FIGS. 3A-3B illustrate an exemplary flowchart for a processor computing a histogram incorporating aspects of the disclosed embodiments; and

FIG. 4 is a block diagram of an exemplary apparatus that can be used to practice aspects of the disclosed embodiments.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

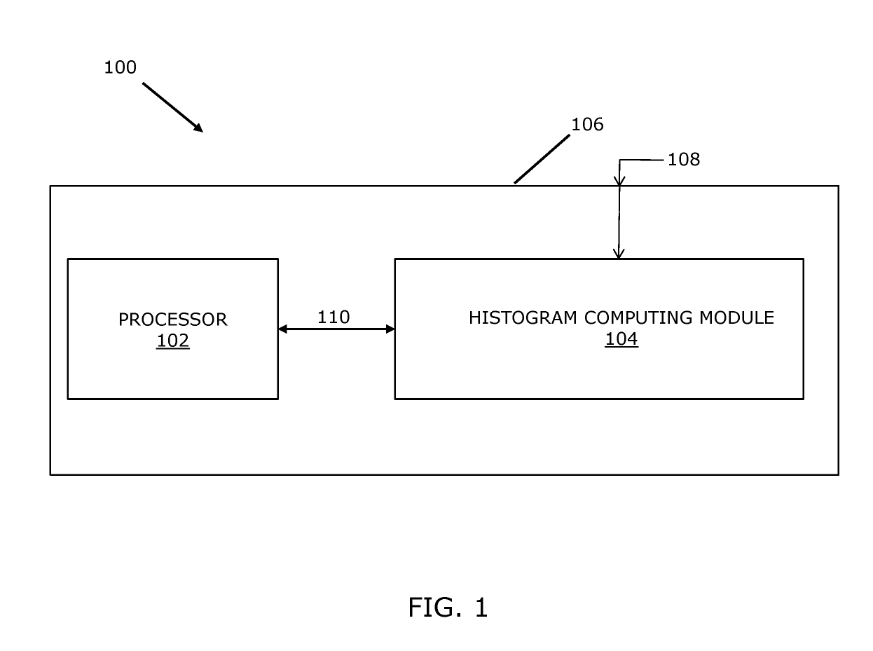

Referring to FIG. 1, the aspects of the disclosed embodiments are directed to computing a histogram based on data measurements taken serially without the need for a general purpose processor to perform the computations. The aspects of the disclosed embodiments provide improved memory savings and increased speed in the computation of the histogram by using a hardware logic design based on a Field Programmable Gate Array (FPGA) device. The logic design of the disclosed embodiments provides for large amounts of measurement data to be consolidated into a relatively small memory space while preserving critical information.

FIG. 1 illustrates a block diagram of a system 100 for computing a histogram incorporating aspects of the disclosed embodiments. As shown in FIG. 1, the system 100 primarily includes a processor 102 and a histogram computing module 104. In the example of FIG. 1, the processor 102 and the histogram computing module 104 are component parts of a Field Programmable Logic Array (FPGA) device, generally referenced as FPGA 106. Although the processor 102 and the histogram computing module 104 are shown in the example of FIG. 1 as separate devices or components, the aspects of the disclosed embodiments are not so limited. In alternate embodiments, the processor 102 and histogram computing module 104 can comprises a single device or component element of the FPGA 106. In one embodiment, the processor 102 and the histogram computing device 104 are part of a computing device such as, but not limiting to, a server device, a computer, a laptop computer, a tablet computer, a smart phone, or any combination of these.

The histogram computing module 104 is configured to compute the histogram based on the measurement data written by the processor 102. As is generally understood, the histogram may be a graphical representation, such as a bar graph, showing a frequency distribution, or some function of numerical data. In the histogram, height of vertical rectangles is proportionate to corresponding frequencies of data. Further, the histogram may be an estimate of probability distribution of a continuous variable for example, temperature, time, etc. Further, it is an estimate of the probability distribution of a continuous variable (such as, quantitative variable). In one embodiment, the computed histogram will be output and presented on a display of a computing device, as is described herein.

In one embodiment, as will be generally understood, the FPGA 106 is a circuit including an array of programmable logic gates for example, but not limiting to, AND gates, OR gates and so forth. In another embodiment, the FPGA 106 is a hardware device including a combination of sequential logic circuits and/or combinational logic circuits. Both the processor 102 and the histogram computing module 104 can also comprise hardware devices including a combination of logic circuits.

As shown in the example of FIG. 1, the FPGA 106 includes at least a first synchronous parallel port 108 and at least a second synchronous parallel port 110. The at least a first synchronous parallel port 108 of the FPGA 106 is generally configured to allow the processor 102 to write measurement data into the histogram computing module 104, as will be further described herein. The histogram computing module 104 is configured to manage data by computing the histogram based on the written measurement data. The first synchronous port 108 may be an input port from where the inputs such as measurement data, come into the histogram computing module 104 or the FPGA 106.

The at least one second synchronous parallel port 110 is generally configured to allow the computed histogram to be read out at an appropriate time. In one embodiment, the at least one second synchronous parallel port 110 is separate from the at least one first synchronous parallel port 108. The at least one second synchronous parallel port 110 can be configured to make the histogram data corresponding to a selected histogram bin available to the processor 102 at a next clock edge, as will be further described herein. The second synchronous port 110 may be an output port from where the computed histogram (i.e. the histogram data) is read back by either the processor 102 or a state machine. As shown, the processor 102 may also be configured to read the histogram data via the second synchronous parallel port 110.

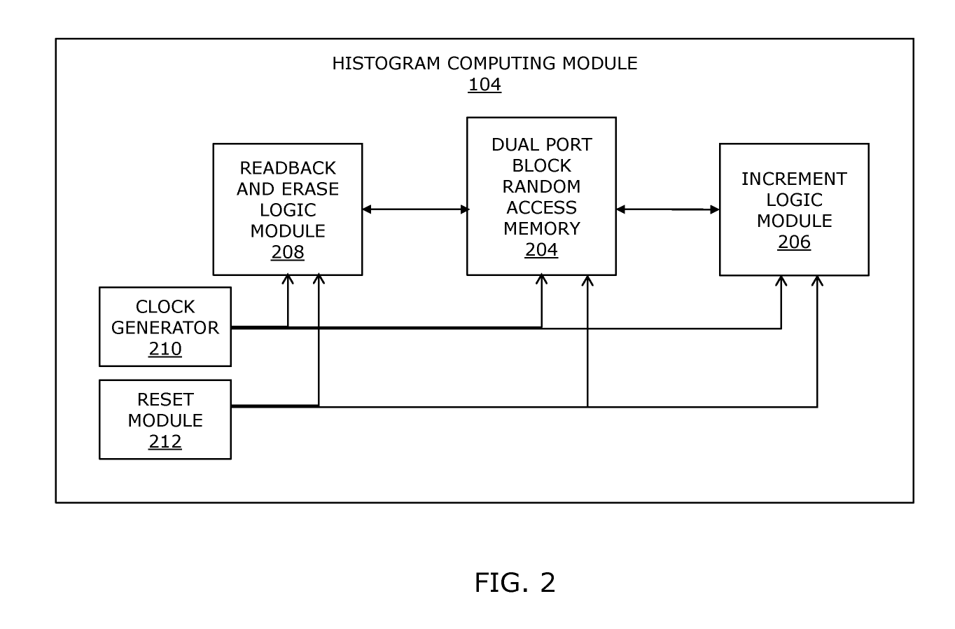

Referring to FIG. 2, a block diagram showing various system elements of an exemplary histogram computing module 104 incorporating aspects of the disclosed embodiments is illustrated. As shown in FIG. 2, the histogram computing module 104 includes a dual port block random access memory 204 (BRAM), an increment logic module 206, and a readback and erase logic module 208. In alternate embodiments, the histogram computing module 104 of the FPGA 106 can include such other components and devices in order to compute a histogram as is generally described herein.

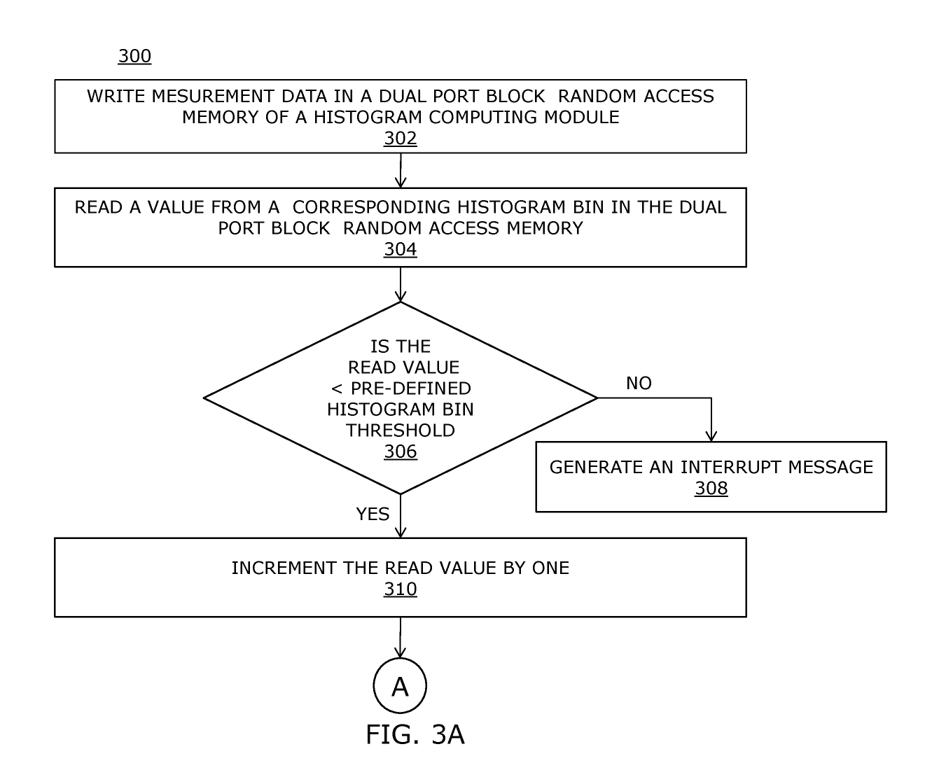

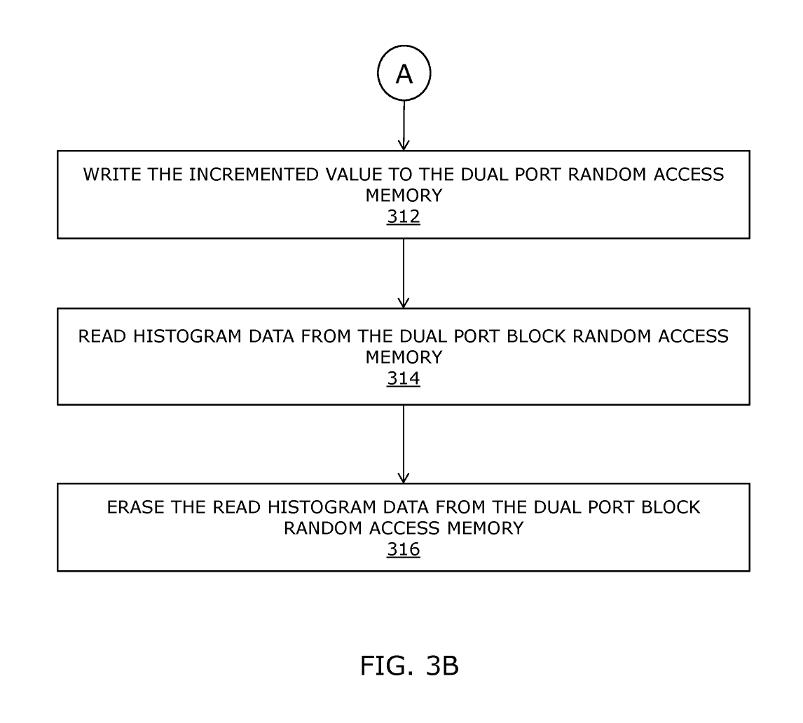

Referring to FIGS. 3A-3B, a method for computing a histogram incorporating aspects of the disclosed embodiments is illustrated. At step 302, measurement data is written into the dual port BRAM 204 of the histogram computing module 104 by the processor 102. At step 304, a value corresponding to a histogram bin stored in the dual port BRAM 204 is read by the increment logic module 206. At step 306, the increment logic module 206 compares the read value with a pre-defined histogram bin threshold to check whether the read value is less than the pre-defined threshold. If yes at step 306, then step 310 is followed else step 308 is executed. At step 308, the increment logic module 206 generates an interrupt message.

At step 310, the increment logic module 206 increments the read value by one. Then at step 312, the increment logic module 206 writes the incremented value back to the dual port BRAM 204. At step 314, the processor 102 reads histogram data from the dual port BRAM 204. Thereafter, at step 316, the read and erase logic module 208 erases or clears the read histogram data from the dual port BRAM 204. In one embodiment, the steps 302-316 are typically repeated for a number of cycles or until an interrupt is generated.

As described above with respect to FIGS. 3A-3B, the histogram computing module 104 is configured to compute the histogram based on the measurement data that is written to the dual port BRAM 204 by the processor 102. The dual port BRAM 204 is configured to store the measurement data written by the processor 102. The measurement data can be stored in the dual port BRAM 204 in the form of blocks, where each blocks can have a unique address and can be accessed by an address vector. Each block of the measurement data may include one or more values corresponding to a histogram bin.

The dual port BRAM 204 can also be configured to store one or more of the histogram data for the computed histogram and the histogram bins. In one embodiment, the dual port BRAM 204 can comprise one or more of software, firmware, hardware including a combination of a sequential logic circuit and/or combinational logic circuit, or combination of these. In one embodiment, the dual port BRAM 204 may be a combination of sequential logic and may include a combination of flip-flops and logic gates).

Referring again to FIG. 2, in one embodiment, the increment logic module 206 is configured to compute the histogram from the measurement data written by the processor 102 as is generally described herein. For each of the histogram bins stored in the dual port BRAM 204, the increment logic module 206 is configured to read a value of the one or more values from a histogram bin. In one embodiment, the increment logic module 206 compares the read value from the histogram bin with a pre-defined histogram bin threshold. The pre-defined histogram bin threshold may be a maximum value pre-set numerical value based on the measurement data. The increment logic module 206 is further configured to increment the read value by one when the read value is less than a pre-defined histogram bin threshold. The increment logic module 206 is configured to write the incremented value back to the dual port BRAM 204.

In one embodiment, the increment logic module 206 is configured to generate an interrupt message when the read value of the histogram bin is more than the pre-defined histogram bin threshold. The increment logic module 206 may also be configured to alert the processor 102 there may be an impending overflow via the generation of the interrupt message and/or the error message. Further, when the increment logic module 206 determines that the read data value is more than the pre-defined threshold, then the read value may not be incremented by one and/or the interrupt message and/or error message is generated. In one embodiment, the increment logic module 206 is a hardware device including a combination of a sequential logic circuit and/or combinational logic circuits.

For example, if the pre-defined histogram bin threshold for temperature data that is measured serially is “100 degree Celsius” and the read value from a histogram bin is more than the “100 degree Celsius”, the increment logic module 206 will not increment the read value. In this case, the increment logic module 206 generates an interrupt message and/or an error message indicating that the histogram bin has exceeded a given threshold. The interrupt message can be used to alert the processor 102 that there may be an impending overflow.

In one embodiment, the read back and erase logic module 208 is configured to select a histogram bin using an address vector from the dual port BRAM 204. The read back and erase logic module 208 may also be configured to strobe a read enable signal to read histogram data corresponding to the selected histogram bin from the dual port block BRAM 204 through, for example, the second synchronous parallel port 110. In one embodiment, the read back and erase logic module 208 is configured to automatically clear the histogram data for the selected histogram bin from the dual port BRAM 204 after the histogram data is read out by the processor 102 on the next clock edge. In one embodiment, the read back and erase logic module 208 is a hardware device including a combination of a sequential logic circuit and/or combinational logic circuit.

In one embodiment, the histogram computing module 104 also includes a clock or clock generator 210 and a reset module 212. The clock generator 210 generally comprises an electronic oscillator configured to generate clock signals. The clock signals may be supplied to the increment logic module 206, the readback and erase logic module 208, and the dual port BRAM 204 via a synchronous parallel port such as, the first synchronous port 108.

In an embodiment, the increment logic module 206, the readback and erase logic module 208, and dual port BRAM 204 may include sequential circuitry that can be in a synchronous mode or an asynchronous mode. In the synchronous mode, the clock generator 210 may be configured to generate a sequence of repetitive pulses called the clock signals that may be distributed to the increment logic module 206, the readback and erase logic module 208, and dual port BRAM 204. In one embodiment, the dual port BRAM 204 may be a combination of sequential logic (i.e. a combination of flip-flops and logic gates). The output of each flip-flop only changes when triggered by a clock signal (that can be positive edge triggered or a negative edge triggered). This may result in changes to the logic signals throughout the circuit, i.e. FPGA 106, so that all modules begin at the same time, at regular intervals, synchronized by the clock signal.

In one embodiment, the reset module 212 is configured to generate and supply a reset signal. The reset signal may clear any pending errors or events and brings the system 100 and FPGA 106, including the histogram computing module 104, to a normal condition or to an initial state, usually in a controlled manner. For example, the reset signal may clear space at all blocks in the dual port BRAM 204 by writing zero to all the addresses of the block.

In the example of FIG. 2, all the modules of the histogram computing module or device 104 are coupled or connected to each other via a data bus. The data bus can be any known data bus architecture, such as for example, but not limiting to, ARM Advanced Microcontroller Bus Architecture (ARM AMBA). In alternate embodiments, the modules of the histogram computing device 104 can be inter-connected in any suitable manner.

The processor 102 is configured to write measurement data including a number of values into the histogram computing module 104. In an embodiment, the processor 102 writes the measurement data into the dual port block random access memory (BRAM) 204. In another embodiment, the processor 102 writes the measurement data into a number of addresses in the dual port BRAM 204. The processor 102 is configured to write measurement data including a number of values into the dual port BRAM 204 via the first synchronous parallel port 108.

The measurement data can include for example, multiple values measured serially. For example, timing data, temperature, such as 5 degrees Celsius, 10 degrees Celsius, 20 degrees Celsius, 35 degrees Celsius, 45 degrees Celsius, 75 degrees Celsius and so forth, voltages, currents, and so forth. The values of the measurement data may include a number histogram bins. Each of the histogram bins defines an interval including a minimum value, a maximum value, and one or more values of the multiple values lying between the minimum value and the maximum value. In an embodiment, the values of the measurement data and the histogram bins include numeric values. In some embodiments, the histogram bins are consecutive and non-overlapping intervals of a variable. As multiple data values (large volume of data) may be represented as the histogram, this may result in saving of space in the memory, for example the BRAM 204.

In an embodiment, the histogram computing module 104 is also configured to divide the entire range of the measurement data into a series of multiple histogram bins and count one or more values falling in each of the histogram bins. For example, consider a set of measurement data 10, 11.5, 13, 13.5, 14, 16, 17, 18, 19, 20, 21, 21.5, 23, 24, 24.5, and 25. This data can be divided into three histogram bins. A first histogram bin may have a minimum value of 11 and maximum value of 15 includes values 11.5, 13, 13.5, and 14. A second histogram bin may have a minimum value 16 and maximum value 20 and may include values 17, 18, and 19. A third histogram bin may include a minimum value 21, a maximum value 25, and include values 21.5, 23, 24, and 24.5.

In another example, consider 100,000 measurements of time. If only a statistical distribution of these measurements is needed without caring about their sequential order, then the amount of data may be divided into a 5000 bin histogram. The aspects of the disclosed embodiments can advantageously reduce the size of the data storage needed to store the 100,000 measurement data.

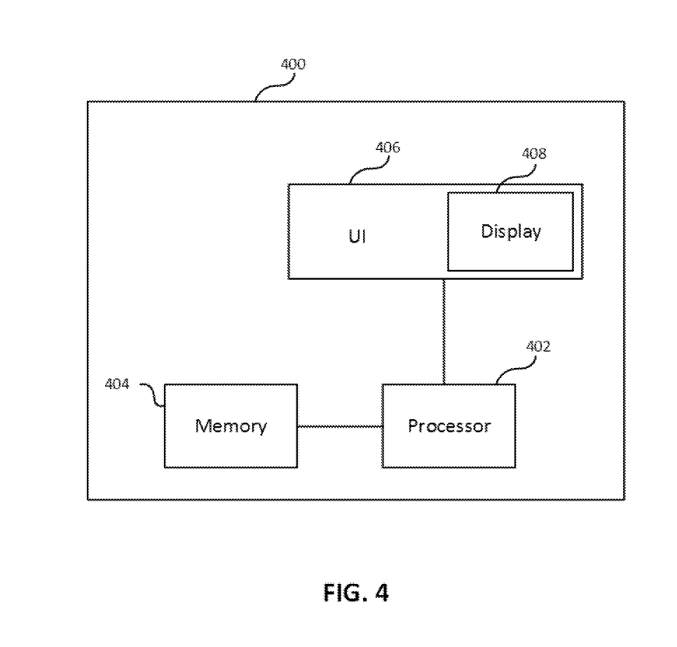

FIG. 4 illustrates a block diagram of a computing apparatus 400 that can be used to practice aspects of the present disclosure. The apparatus 400 is appropriate for implementing embodiments of the apparatus and methods described herein. The computing apparatus 400 may include the system 100 (not shown), including the FPGA 106. In one embodiment, the computing apparatus 400 comprises a logic board and associated devices configured for space flight. For example, the computing apparatus 400 can include or be a part of an avionics assembly board for a spacecraft.

The apparatus 400 generally includes a processor 402 coupled to a memory 404. The apparatus 400 can also include a user interface (UI) 406. The user interface 406 can be part of the apparatus 400, or an external device that is coupled to or connected to the apparatus 400. The user interface 406 can include a display 408. In one embodiment, the computed histogram can be presented on the display 408. The processor 402 may be a single processing device or may comprise a plurality of processing devices including special purpose devices, such as for example digital signal processing (DSP) devices, microprocessors, or other specialized processing devices as well as one or more general purpose computer processors including parallel processors or multi-core processors. The processor 402 is configured to perform embodiments of the processes described herein. In one embodiment, the processor 402 can include or be connected to the FPGA 106 as is generally described herein.

The processor 402 is coupled to a memory 404 which may be a combination of various types of volatile and/or non-volatile computer memory such as for example read only memory (ROM), random access memory (RAM), magnetic or optical disk, or other types of computer memory. The memory 404 stores computer program instructions that may be accessed and executed by the processor 402 to cause the processor 402 to perform a variety of desirable computer implemented processes or methods as are described herein. The program instructions stored in memory 404 may be organized as groups or sets of program instructions referred to by those skilled in the art with various terms such as programs, software components, software modules, units, etc., where each program may be of a recognized type such as an operating system, an application, a device driver, or other conventionally recognized type of software component. Also included in the memory 404 are program data and data files which may be accessed, stored, and processed by the computer program instructions.

In an embodiment of an apparatus 400 that includes a UI 406, the UI 406 may include one or more user interface elements such as a touch screen, keypad, buttons, voice command processor, as well as other elements adapted for exchanging information with a user.

As an example, the NASA Gravity and Extreme Magnetism Small Explorer (GEMS) required taking a large number of timing measurements for an in-flight calibration system. The measurements were taken using an FPGA, such as the FPGA 106, to control a simple detector system. By consolidating the measurements into a histogram using on-board FPGA logic, such as the system 100, the large number of measurements could be consolidated into a relatively small memory space while preserving the critical information. The aspects of the disclosed embodiments were advantageous in efficiently storing and transferring the large number of measurements without consuming a significant quantity of FPGA resources that were necessary for the rest of the instrument to function.

The aspects of the disclosed embodiments provides a system that is a logic design for computing a histogram based on individual measurement data taken serially. The disclosed system may provide memory savings by storing a large volume of data into a single histogram that is a graphical representation of the large volume of the data. Further, the disclosed system enhances the speed of the computation of a histogram by increasing the pipelining.

When a traditional processor is used for performing all the steps of computing a histogram, then at least three operations for each measurement sample are performed by the processor. However, the aspects of the disclosed embodiments enable a single operation i.e., specifying a memory location or an address of the dual port BRAM to the histogram computing module. The histogram computing module addresses the other computation steps, i.e. the reading data value, incrementing data value, and writing back the incremented value. Since, these operations are pipelined in the histogram computing module, the processor can specify one memory location on every clock cycle rather than one for every 3 clock cycles.

In accordance with the aspects of the disclosed embodiment, most of the histogram computation is done by the histogram computing module 104 or the FPGA 106. The burden on the processor is reduced and may possibly eliminate the need of the processor for computing histograms.

Further, the aspects of the disclosed embodiments provide a system for data managing in which the input/output can be assigned to an internal data bus (such as ARM AMBA). This can be used by the processor for reducing the number of instructions needed for histogram calculation or for allowing parallel processing for computing histograms by the histogram computing module.

Thus, while there have been shown, described and pointed out, fundamental novel features of the invention as applied to the exemplary embodiments thereof, it will be understood that various omissions, substitutions and changes in the form and details of devices and methods illustrated, and in their operation, may be made by those skilled in the art without departing from the spirit and scope of the invention. Further, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A system for computing a histogram, the system comprising a processor and a histogram computing module, wherein the processor is configured to:
write measurement data comprising a plurality of values into the histogram computing module, the plurality of values of the measurement data comprising a plurality of histogram bins, wherein each histogram bin defines an interval including a minimum value, a maximum value, and one or more values of the plurality of values lying between the minimum value and the maximum value; and wherein
the histogram computing module is configured to compute the histogram based on the measurement data, the histogram computing module comprising:
a dual port block random access memory configured to store the measurement data; and
an increment logic module configured to:
read a value of the one or more values from a histogram bin from at least one of the plurality of histogram bins;
increment the read value by one when the read value is less than a pre-defined histogram bin threshold; and
write the incremented value back to the dual port block random access memory.

2. The system of claim 1, wherein the dual port random access memory is further configured to store histogram data of the computed histogram.

3. The system of claim 2, wherein the processor and histogram computing module comprise a Field Programmable Gate Array (FPGA) device.

4. The system of 3, wherein the field programmable gate array further comprises:
at least a first synchronous parallel port configured to allow the processor to write the measurement data into the dual port block random access memory; and
at least a second synchronous parallel port configured to make the histogram data of the computed histogram available to the processor at a next clock edge.

5. The system of claim 4, wherein the field programmable gate array further comprises a read back and erase logic module configured to:
select a histogram bin stored in the dual port block random access memory using an address vector from the dual port block random access memory; and
strobe a read enable signal to read histogram data corresponding to the selected histogram bin from the dual port block random access memory through the at least second synchronous parallel port.

6. The system of claim 5, wherein the processor is further configured to read the histogram data corresponding to the selected histogram bin from the at least second synchronous parallel port on the next clock edge.

7. The system of claim 6, wherein the read back and erase logic module is further configured to automatically clear the histogram data for the selected histogram bin from the dual port block random access memory after the histogram data is read out by the processor on the next clock edge.

8. The system of claim 1, wherein the increment logic module is further configured to compare the read value of the one or more values from the histogram bin with the pre-defined histogram bin threshold.

9. The system of claim 8, wherein the increment logic module is configured to generate an interrupt message when the read value of the histogram bin is more than the pre-defined histogram bin threshold.

10. The system of claim 1, further comprising a computing device configured to display the computed histogram on a display of the computing device.

11. A method for computing a histogram using a Field Programmable Gate Array (FPGA) device including at least a processor and a histogram computing module, the method comprising:
writing measurement data comprising a plurality of values into a dual port block random access memory of the histogram computing module, wherein the plurality of values of the measurement data comprise a plurality of histogram bins and each of the plurality of histogram bins defines an interval including a minimum value, a maximum value, and one or more values of the plurality of values lying between the minimum value and the maximum value;
and computing the histogram corresponding to the written measurement data by:
reading a value from a histogram bin for each of the plurality of histogram bins stored in the dual port block random access memory;
incrementing the read value by one when the read value is less than a pre-defined histogram bin threshold; and
writing the incremented value back to the dual port block random access memory.

12. The method of claim 11 further comprising storing the histogram data of the computed histogram in the dual port block random access memory.

13. The method of claim 12, further comprising:
writing the measurement data into the dual port block random access memory through at least a first synchronous parallel port; and
making histogram data corresponding to the computed histogram available to the processor through at least a second synchronous parallel port at a next clock edge.

14. The method of claim 13 further comprising:
selecting a histogram bin using an address vector from the dual port block random access memory; and
strobing a read enable signal to read histogram data corresponding to the selected histogram bin from the dual port block random access memory through the at least second synchronous parallel port.

15. The method of 14 comprising reading the histogram data corresponding to the selected histogram bin from the at least second synchronous parallel port on the next clock edge.

16. The method of 15 comprising automatically clearing the histogram data for the selected histogram bin from the dual port block random access memory after the histogram data is read out by the processor on the next clock edge.

17. The method of claim 11 comprising comparing the read value of the one or more values from the histogram bin with the pre-defined histogram bin threshold.

18. The method of claim 17 comprising generating an interrupt message when the read value of the histogram bin is more than the pre-defined histogram bin threshold.
